(19) United States
(12) Patent Application Publication
(10) Pub. No.: US 2024/0390789 A1
(43) Pub. Date: Nov. 28, 2024

(54) METHOD FOR CONTROLLING CLOUD GAME, AND STORAGE MEDIUM, AND ELECTRONIC DEVICE THEREOF

(71) Applicant: Guangzhou Boguan Telecommunication Technology Co., Ltd., Guangzhou, Guangdong (CN)

(72) Inventor: Xiaoyu MO, Guangzhou, Guangdong (CN)

(73) Assignee: Guangzhou Boguan Telecommunication Technology Co., Ltd., Guangzhou, Guangdong (CN)

(21) Appl. No.: 18/695,014

(22) PCT Filed: Jun. 10, 2022
(86) PCT No.: PCT/CN2022/098212

§ 371 Date: Mar. 25, 2024

(30) Foreign Application Priority Data
Dec. 2, 2021 (CN) 202111459162.8

(51) Int. Cl. A63F 13/42; A63F 13/2145; A63F 13/24; A63F 13/355

(52) U.S. Cl. CPC A63F 13/42; A63F 13/355; A63F 13/2145; A63F 13/24

(57) ABSTRACT

A method for controlling a cloud game, including: obtaining an operation instruction input by a first game client, and converting the operation instruction into a game instruction; where a type of the operation instruction is determined according to a game platform corresponding to the first game client, a type of the game instruction is a type of an instruction to be received by a cloud game server, and the game instruction is configured to indicate a game operation to be performed; and, sending the game instruction to the cloud game server, where the cloud game server controls a game virtual object to perform the game operation according to the game instruction.

### CROSS REFERENCE TO RELATED APPLICATIONS

The present application is a National Stage Application of International Application No. PCT/CN2022/098212 filed on Jun. 10, 2022 which is based upon and claims priority to Chinese Patent Application No. 202111459162.8 entitled “Method and apparatus for controlling cloud game, storage medium, and electronic device”, filed on Dec. 2, 2021, and the entire contents of both of which are incorporated herein by reference for all purposes.

### TECHNICAL FIELD

The present disclosure relates to the field of game technology, and in particular, to a method for controlling a cloud game, an apparatus for controlling a cloud game, a computer-readable storage medium, and an electronic device.

### BACKGROUND

With the development of the terminal device and the game industry, a cloud game based on cloud computing appears. The cloud game refers to that the game runs at the server, the rendered game screen is compressed and then transmitted to the user through the network. At the client, the game device of the user does not need a high-end configuration, and only needs to have a basic video decompression capability.

It should be noted that the information disclosed in the background part is only configured to enhance the understanding of the background of the present disclosure, and therefore may include information that does not constitute the relate art known to those of ordinary skills in the art.

### SUMMARY

According to a first aspect of the present disclosure, there is provided a method for controlling a cloud game, performed on a terminal device or a server, and including: obtaining an operation instruction input by a first game client, and converting the operation instruction into a game instruction; where a type of the operation instruction is determined according to a game platform corresponding to the first game client, a type of the game instruction is a type of an instruction to be received by a cloud game server, and the game instruction is configured to indicate a game operation to be performed; and, sending the game instruction to the cloud game server, where the cloud game server controls a game virtual object to perform the game operation according to the game instruction.

According to a second aspect of the present disclosure, there is provided a non-transitory computer-readable storage medium storing a computer program; when the program is executed by a processor, the method for controlling a cloud game according to the first aspect in the above embodiment is implemented.

According to a third aspect of the present disclosure, there is provided an electronic device, including:
one or more processors; and
a memory, configured to store one or more programs; when the one or more programs are executed by the one or more processors, the one or more processors are enabled to implement the method for controlling a cloud game according to the first aspect in the above embodiment.

It should be understood that the above general description and the following detailed description are exemplary and explanatory only and are not intended to limit the present disclosure.

### BRIEF DESCRIPTION OF THE DRAWINGS

The accompanying drawings, which are incorporated in and constitute a part of the description, illustrate embodiments consistent with the disclosure and together with the description serve to explain the principles of the disclosure. Obviously, the drawings in the following description are merely some embodiments of the present disclosure, and for those of ordinary skill in the art, other drawings can also be obtained from these drawings without creative efforts.

FIG. 1 schematically shows a flowchart of a method for controlling a cloud game according to some embodiments of the present disclosure;

FIG. 2 schematically shows a flowchart of obtaining an operation instruction input by a second game client and converting the operation instruction into a game instruction according to some embodiments of the present disclosure;

FIG. 3 schematically shows a flowchart of converting an operation instruction into a game instruction according to an instruction mapping rule according to some embodiments of the present disclosure;

FIG. 4 schematically shows a flowchart of converting a back-transmission game instruction into an operation instruction corresponding to a game platform of a first game client through an instruction conversion interface according to some embodiments of the present disclosure;

FIG. 5 schematically shows a flowchart of obtaining a game screen by decoding screen information on a first game client and displaying the game screen on a display component of the first game client according to some embodiments of the present disclosure;

FIG. 6 schematically shows a flowchart of converting the operation instructions into game instructions through an SDK according to some embodiments of the present disclosure;

FIG. 7 schematically shows a flowchart of transferring an operation permission of a first game client to a second game client according to some embodiments of the present disclosure;

FIG. 8 schematically shows a schematic diagram of unifying operation instructions input by different game clients into game instructions according to some embodiments of the present disclosure;

FIG. 9 schematically shows a schematic composition diagram of an apparatus for controlling a cloud game according to some embodiments of the present disclosure;

FIG. 10 schematically shows a schematic structural diagram of a computer system suitable for implementing an electronic device according to some embodiments of the present disclosure.

### DETAILED DESCRIPTION

Example embodiments will now be described more fully with reference to the accompanying drawings. Example embodiments, however, can be implemented in various forms and should not be construed as limited to the embodiments set forth herein; by contrast, these embodiments are provided so that the present disclosure will be thorough and complete, and will fully convey the concept of example embodiments to those skilled in the art. The described features, structures, or characteristics may be combined in any suitable manner in one or more embodiments In the following description, numerous specific details are provided to give a thorough understanding of embodiments of the present disclosure. However, those skilled in the art will appreciate that the technical solutions of the present disclosure may be practiced without one or more of the specific details, or, other methods, components, devices, steps, or the like, may be employed. In other instances, well-known structures, methods, devices, implementations, materials, or operations are not shown or described in detail to avoid obscuring various aspects of the present disclosure.

The block diagrams shown in the drawings are merely functional entities, which do not necessarily correspond to physically independent entities. That is, these functional entities may be implemented in the form of software; or, these functional entities or a part of these functional entities may be implemented in one or more software-hardened modules; or, these functional entities may be implemented in different networks and/or processor devices and/or microcontroller devices.

With the development of the terminal device and the game industry, a cloud game based on cloud computing appears. The cloud game refers to that the game runs at the server, the rendered game screen is compressed and then transmitted to the user through the network. At the client, the game device of the user does not need a high-end configuration, and only needs to have a basic video decompression capability.

In the related art, for the same cloud game, a plurality of game devices may be supported. For example, for the same game, different game devices may be used for playing; for example, a mobile phone may be used for playing; or, a computer may also be used for playing; or, a game machine may also be used for playing. Among them, the instruction input manner of each game device may also be different; for example, when it is played through the mobile phone, a game virtual object may be controlled to perform the game action through a touch operation acting on the mobile phone screen; or, when it is played through the computer, the game virtual object may be controlled to perform the game action through a key operation of the keyboard; or, when it is played through the game machine, the game virtual object may be controlled to perform the game action through a key operation of the handle. That is, for the same game, different game devices may be used for playing; and, game control manners of different game devices may also be different.

Due to different game devices, input manners for the same instruction on different game devices are different. For example, for controlling the game virtual object to jump, the game virtual object is controlled to jump by clicking the jump control on the mobile phone screen at the mobile phone end, the game virtual object is controlled to jump through the space key on the keyboard at the computer, and the game virtual object is controlled to jump through the A key on the handle at the game machine. For another example, for controlling the game virtual object to attack, the game virtual object is controlled to attack by clicking the attack control on the mobile phone screen at the mobile phone end, the game virtual object is controlled to attack through the left key of the mouse at the computer, and the game virtual object is controlled to attack through the X key on the handle at the game machine. For another example, for controlling the game virtual object to move, the game virtual object is controlled to move by sliding the movement control on the mobile phone screen at the mobile phone end, the game virtual object is controlled to move through the right key of the mouse at the computer, and the game virtual object is controlled to move through the rocker on the handle at the game machine.

Therefore, when the game is produced, the instruction input manners of the same instruction in different game devices need to be considered and adaptively developed for each game device. For example, for a jump instruction in the game, corresponding instructions need to be produced for the mobile phone end, the computer end and the game machine end respectively, thus increasing the game development cost. In addition, when the user plays the same game on different game devices, the user may need to adjust the control manner of the game, thus increasing the playing cost of the user, so that the game experience of the user is poor, and a part of users is lost.

In view of this, the purpose of the present disclosure is to provide a method and apparatus for controlling a cloud game, a computer-readable storage medium, and an electronic device, which may solve the problem that corresponding operation instructions for the same game operation at different game clients are different.

The method for controlling a cloud game in an embodiment of the present disclosure may run on a terminal device or a server. Among them, the terminal device may be a local terminal device. When the method for controlling a cloud game runs on the server, the method for controlling a cloud game may be implemented and performed based on the cloud interaction system, where the cloud interaction system includes a server and a client device.

In an optional implementation, various cloud applications may run in the cloud interaction system, such as a cloud game. Taking a cloud game as an example, a cloud game refers to a game manner based on cloud computing. In the running mode of the cloud game, the running body of the game program and the game screen presentation body are separated; the storage and running of the method for controlling a cloud game are completed on the cloud game server; and, the role of client devices is to receive and send data, as well as present the game screen. For example, the client device may be a display device with a data transmission function close to the user side, such as a mobile terminal, a television, a computer, a palm computer or the like; however, the terminal device for performing information processing is the cloud game server of the cloud. When performing a game, the player operates the client device to send an operation instruction to the cloud game server; the cloud game server runs the game according to the operation instruction, encodes and compresses the data such as the game screen, and returns the data to the client device through the network; and finally, the data is decoded and the game screen is output through the client device.

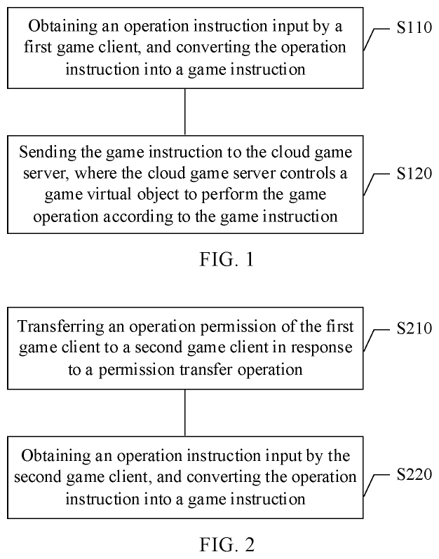

In some embodiments of the present disclosure, an operation instruction input by the first game client may be obtained, and the operation instruction may be converted into a game instruction. Among them, the type of the operation instruction is related to the game platform corresponding to the game client, and the type of the game instruction is related to the cloud game server. The game instruction is sent to the cloud game server, so that the cloud game server controls the game to perform the corresponding game operation according to the game instruction. Referring to FIG. 1, it shows a flowchart of a method for controlling a cloud game according to some embodiments, which may include the following step.

In step S110, an operation instruction input by a first game client is obtained, and the operation instruction is converted into a game instruction. Among them, the type of the operation instruction is related to a game platform corresponding to the game client, the type of the game instruction is related to the cloud game server, and the game instruction is configured to indicate a game operation to be performed.

In step S120, the game instruction is sent to a cloud game server, so that the cloud game server controls the game to perform a corresponding game operation according to the game instruction.

In the method for controlling a cloud game provided by the embodiment of the present disclosure, the operation instruction input by the client can be converted into the game instruction corresponding to the server, and the game operation can be controlled according to the converted game instruction. On one hand, the game developer does not need to perform adaptive development for different game devices, avoiding consideration of the instruction input manner of the same instruction in different game devices, reducing the repeated work of the developer, and further reducing the development cost of the game. On the other hand, since the instruction input by the game device is converted into the instruction corresponding to the server, the user does not need to adjust the control manner, reducing the playing cost of the user and improving the game experience of the player.

In some embodiments of the present disclosure, the game in the solutions of the present disclosure may include various types of games, such as TPS (third-person shooter), FPS (first-person shooter), RPG (role-playing game), ACT (action game), SLG (simulation game), FTG (fighting game), SPG (sports game), RCG (racing game), AVG (adventure game), etc. As long as the game instruction conversion scene is involved, the control solution for the cloud game of the present disclosure can be applied. It should be noted that the type of the game is not specifically limited in the present disclosure.

In the following, steps S110 to S120 of the method for controlling a cloud game in the example embodiment will be described in more detail with reference to FIG. 1 and the embodiments.

In step S110, an operation instruction input by a first game client is obtained, and the operation instruction is converted into a game instruction.

In some embodiments of the present disclosure, the first game client may include various game clients. For example, the first game client may include a mobile phone client, the first client may further include a computer client, and the first client may further include a game machine client. It should be noted that the specific type of the game client is not specifically limited in the present disclosure.

In an embodiment of the present disclosure, the operation instruction input by the first game client may be obtained. In some embodiments, the operation instruction refers to an instruction input through the first game client. The operation instruction may include a keyboard key instruction, a touch instruction, a voice control instruction, a handle key instruction, etc. Among them, the touch instruction may include a sliding touch instruction, a pressing touch instruction, a gesture touch instruction, a long press touch instruction, a click touch instruction, a dragging touch instruction, etc. For example, the first game client is a mobile phone client, and the player may control the game to perform a corresponding game operation through a touch instruction acting on the mobile phone screen; that is, the touch instruction may be obtained at this time. It should be noted that the specific form of the operation instruction is not specifically limited in the present disclosure.

Among them, the type of the operation instruction is related to a game platform corresponding to the game client. For example, if the game client is a mobile phone client, the corresponding game platform is a mobile phone platform, and the type of the operation instruction is a touch input type; that is, the player may control the game to perform a corresponding game operation through a touch instruction acting on the mobile phone screen. If the game client is a game machine client, the corresponding game platform is a game machine platform, and the type of the operation instruction is a handle input type; that is, the player may control the game to perform a corresponding game operation through a key or a rocker on the handle. If the game client is a computer client, the corresponding game platform is a computer platform, the type of the operation instruction is the keyboard and mouse input type; that is, the player may control the game to perform a corresponding game operation through a key on the keyboard or a mouse. It should be noted that the type of the operation instruction and the game platform corresponding to the game client are not specifically limited in the present disclosure.

In some embodiments, for the same game instruction, the types in different game clients are different. For example, for controlling the game virtual object to jump, the game virtual object is controlled to jump by clicking the jump control on the mobile phone screen at the mobile phone end, the game virtual object is controlled to jump through the space key on the keyboard at the computer, and the game virtual object is controlled to jump through the A key on the handle at the game machine. That is, in different game clients, manners for controlling the game virtual object to jump are configured to be different, but the goals to be achieved essentially are the same.

In an embodiment of the present disclosure, after the operation instruction input by the first game client is obtained through the above steps, the operation instruction may be converted into the game instruction. Among them, the type of the game instruction is related to the cloud game server; that is, the type of the game instruction refers to the type corresponding to the cloud game server and capable of being received by the cloud server. The game instruction is configured to indicate the game operation to be performed.

In some embodiments, converting the operation instruction into the game instruction refers to that the type of the operation instruction is converted into the type of the game instruction, that is, the type of the operation instruction input by the game client is converted into the type of the instruction that can be received by the cloud game server. For example, for controlling the game virtual object to jump, it is controlled to jump through the A key at the game machine end; for the game client, the “A key” input by the game client is an operation instruction, the corresponding game instruction is a jump command, and the cloud game server can only receive the game instruction and perform a corresponding game operation according to the game instruction. Therefore, the operation instruction needs to be converted into the game instruction. For example, the game operation corresponding to the operation instruction can be searched, and the instruction corresponding to the game operation can be determined as the game instruction, so as to complete the process of converting the operation instruction into the game instruction. Furthermore, a conversion tool for converting the operation instruction into the game instruction can be configured in the SDK (Software Development Kit), and the operation instruction can be converted into the game instruction through the SDK. It should be noted that the specific manner of converting the operation instruction into the game instruction is not specifically limited in the present disclosure.

In an embodiment of the present disclosure, in response to a permission transfer operation, the operation permission of a first game client may be transferred to a second game client, an operation instruction input by the second game client may be obtained, and the operation instruction may be converted into the game instruction. Referring to FIG. 2, obtaining the operation instruction input by the second game client and converting the operation instruction into the game instruction may include the following steps S210 to S220.

In step S210, in response to a permission transfer operation, an operation permission of a first game client is transferred to a second game client.

In step S220, an operation instruction input by the second game client is obtained, and the operation instruction is converted into the game instruction.

In an embodiment of the present disclosure, in response to the permission transfer operation, the operation permission of the first game client is transferred to the second game client. In some embodiments, in a cloud game, a scene where a plurality of clients interact with each other may be involved, that is, a player transfers the operation permission for the game to another player. The present game client is controlled by another player. At this time, the operation permission of the first game client may be transferred to the second game client in response to the permission transfer operation. In some embodiments, the permission transfer operation may include a key operation, a touch operation, a voice control, etc. Among them, the touch operation may include a sliding touch operation, a pressing touch operation, a gesture touch operation, a long press touch operation, a clicking touch operation, a dragging touch operation, etc. It should be noted that the form of the permission transfer operation is not specifically limited in the present disclosure.

Furthermore, the operation permission of the first game client can be transferred to the second game client through one permission transfer operation, or the operation permission of the first game client can be transferred to the second game client through a plurality of permission transfer operations. For example, the first game client is a mobile phone end; at this time, the game client transfer interface can be opened through one touch operation, and then the game client to be transferred can be selected in the game client transfer interface through one touch operation again. It should be noted that the operation number of the permission transfer operation is not specifically limited in the present disclosure.

In an embodiment of the present disclosure, transferring the operation permission of the first game client to the second game client refers to controlling the game operation of the first game client by the second game client; that is, the game runs through the first game client, and is controlled only by the second game client.

In an embodiment of the present disclosure, after the operation permission of the first game client is transferred to the second game client through the above steps, the operation instruction input by the second game client can be obtained, and the operation instruction can be converted into the game instruction.

In an embodiment of the present disclosure, the first game client receives the game instruction and sends the game instruction to the cloud game server. In some embodiments, after the operation instruction is converted into the game instruction, the converted game instruction can be sent to the first game client, and then the game instruction can be sent to the cloud game server through the first game client.

Through the above steps S210 to S220, in response to the permission transfer operation, the operation permission of the first game client is transferred to the second game client, the operation instruction input by the second game client is obtained, and the operation instruction is converted into the game instruction.

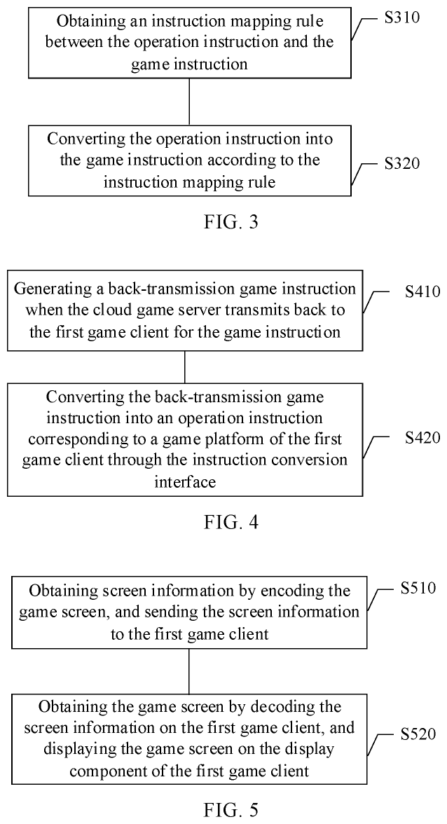

In an embodiment of the present disclosure, an instruction mapping rule between the operation instruction and the game instruction may be obtained, and the operation instruction may be converted into the game instruction according to the instruction mapping rule. Referring to FIG. 3, converting the operation instruction into the game instruction according to the instruction mapping rule may include the following steps S310 to S320.

In step S310, an instruction mapping rule between the operation instruction and the game instruction is obtained.

In step S320, the operation instruction is converted into the game instruction according to the instruction mapping rule.

In an embodiment of the present disclosure, an instruction mapping rule between the operation instruction and the game instruction may be obtained. In some embodiments, the instruction mapping rule between the operation instruction and the game instruction refers to the mapping rule of converting the operation instruction into the game instruction, and the operation instruction may be converted into the game instruction through the instruction mapping rule. Among them, the instruction mapping rule may include an instruction mapping table, the instruction mapping table includes a mapping relationship between the operation instruction and the game instruction, and the operation instruction may be converted into the game instruction through the mapping relationship between the operation instruction and the game instruction. It should be noted that the specific form of the instruction mapping rule is not specifically limited in the present disclosure.

Through the above steps S310 to S320, the instruction mapping rule between the operation instruction and the game instruction can be obtained, and the operation instruction can be converted into the game instruction according to the instruction mapping rule.

In step S120, the game instruction is sent to the cloud game server, so that the cloud game server controls the game to perform a corresponding game operation according to the game instruction.

In an embodiment of the present disclosure, when the game instruction is obtained through the above steps, the game instruction may be sent to the cloud game server. In some embodiments, the conversion process from the operation instruction to the game instruction may be completed in the first game client, and the game instruction may be sent to the cloud game server. In addition, the operation instruction may also be sent to an instruction processing middleware, the conversion process from the operation instruction to the game instruction may be completed in the instruction processing middleware, and the game instruction may be sent to the cloud game server. Among them, the instruction processing middleware may be provided outside the first game client and the cloud game server, or may also be provided in the cloud game server. It should be noted that, the specific position for converting the operation instruction into the game instruction is not specifically limited in the present disclosure. After the game instruction is obtained, the game instruction may be sent to the cloud game server. It should be noted that the specific manner of sending the game instruction to the cloud game server is not specifically limited in the present disclosure.

In an embodiment of the present disclosure, after the game instruction is sent to the cloud game server, the game operation corresponding to the game instruction may be controlled according to the game instruction. For example, the game operation to be performed according to the game instruction is a jump, and at this time, the game virtual object may be controlled to perform a jump operation. It should be noted that the specific manner of controlling the game to perform the corresponding game operation according to the game instruction is not specifically limited in the present disclosure.

In an embodiment of the present disclosure, when the cloud game server transmits back to the first game client for the game instruction, a back-transmission game instruction can be generated, and the back-transmission game instruction can be converted into an operation instruction corresponding to the game platform of the first game client through an instruction conversion interface. Referring to FIG. 4, converting the back-transmission game instruction into an operation instruction corresponding to the game platform of the first game client through the instruction conversion interface may include the following steps S410 to S420.

In step S410, when the cloud game server transmits back to the first game client for the game instruction, a back-transmission game instruction is generated.

In step S420, the back-transmission game instruction is converted into an operation instruction corresponding to the game platform of the first game client through an instruction conversion interface.

In an embodiment of the present disclosure, after the cloud game server controls the game to perform a corresponding game operation according to the game instruction, the cloud game server may send a back-transmission game instruction to the first game client for the game instruction. Among them, the type of the back-transmission game instruction is the same as the type of the game instruction. In some embodiments, in some games, after the game instruction is sent to the cloud game server, the cloud game server may transmit back for the game instruction, and at this time, a back-transmission game instruction may be generated.

In an embodiment of the present disclosure, the cloud game server may include an instruction conversion interface corresponding to a plurality of game platforms. In some embodiments, the instruction conversion interface corresponding to the game platform refers to an interface for converting the back-transmission game instruction into a corresponding type of instruction for the game platform. When the back-transmission game instruction is generated, the game platform corresponding to the first game client may be obtained, the instruction conversion interface corresponding to the game platform may be called in the cloud game server, and the back-transmission game instruction may be converted into the operation instruction corresponding to the game platform of the first game client. It should be noted that, the specific manner of converting the back-transmission game instruction into the operation instruction corresponding to the game platform of the first game client through the instruction conversion interface is not specifically limited in the present disclosure.

Through the above steps S410 to S420, when the cloud game server transmits back to the first game client for the game instruction, a back-transmission game instruction may be generated, and the back-transmission game instruction may be converted into an operation instruction corresponding to the game platform of the first game client through the instruction conversion interface.

In an embodiment of the present disclosure, after the cloud game server controls the game to perform the corresponding game operation according to the game instruction, the game screen may be displayed on the display component of the first game client. In some embodiments, the display component of the first game client refers to a device component configured to display the game screen. For example, for a mobile phone game client, its display component is a mobile phone screen; and for a computer game client, its display component is a display. It should be noted that the specific type of the display component of the first game client is not specifically limited in the present disclosure. After the game screen corresponding to the game is obtained, the game screen may be displayed on the display component of the first client. In some embodiments, the game screen corresponding to the game may be sent to the first game client, and displayed on the display component of the first game client.

In an embodiment of the present disclosure, screen information may be obtained by encoding the game screen, the screen information may be sent to the first game client, the game screen may be obtained by decoding the screen information on the first game client, and the game screen may be displayed on the display component of the first game client. Referring to FIG. 5, obtaining the game screen by decoding the screen information on the first game client and displaying the game screen on the display component of the first game client may include the following steps S510 to S520.

In step S510, screen information is obtained by encoding the game screen, and the screen information is sent to the first game client;

In an embodiment of the present disclosure, after the cloud game server controls the game to perform the corresponding game operation according to the game instruction, the game screen corresponding to the game may be obtained, and screen information may be obtained by encoding the game screen. In some embodiments, image encoding is essentially to compress the image, transform and combine the image source data to be processed according to a certain rule, so that as less symbols as possible may be used to represent as much information as possible. For example, the screen information may be obtained by encoding the game screen through the manner of entropy encoding, predictive encoding, transform encoding, hybrid encoding, or the like. Then, the encoded screen information is sent to the first game client. It should be noted that the specific manner of encoding the game screen to obtain the screen information is not specifically limited in the present disclosure.

In step S520, the game screen is obtained by decoding the screen information on the first game client, and the game screen is displayed on the display component of the first game client.

In an embodiment of the present disclosure, after the first game client obtains the encoded screen information, the screen information may be decoded on the first game client to obtain the game screen. In some embodiments, decoding the screen information is essentially a process of decompressing the encoded screen information; that is, the screen information is decoded into a game screen, and the game screen is displayed the game screen on a display component of the first game client. It should be noted that the specific manner of decoding the screen information to obtain the game screen is not specifically limited in the present disclosure.

Through the above steps S510 to S520, the game screen may be encoded to obtain screen information; the screen information may be sent to the first game client; the screen information may be decoded on the first game client to obtain the game screen; and, the game screen may be displayed on the display component of the first game client.

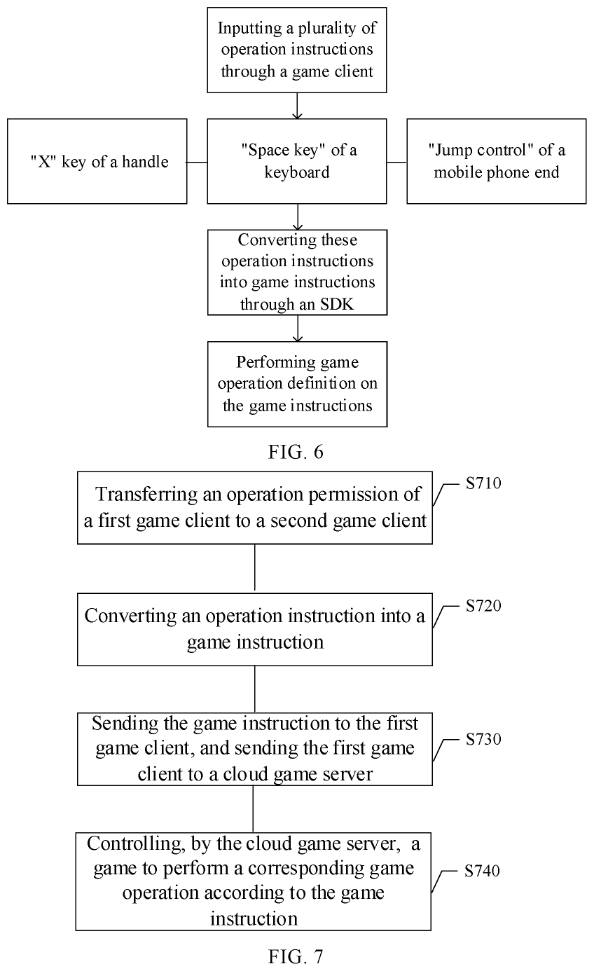

In an embodiment of the present disclosure, referring to FIG. 6, a plurality of operation instructions may be input through a game client, such as a “X” key of a handle, a “Space key” of a keyboard, and a “Jump control” of a mobile phone end. The operation instructions may be converted into game instructions through an SDK, and game operation definition may be performed on the game instructions.

In an embodiment of the present disclosure, when the operation permission of the first game client is transferred to the second game client, the second client can input an operation instruction, convert the operation instruction into a game instruction, send the game instruction to the first game client; The first game client sends the received the game instruction to the cloud game server, so that the cloud game server controls the game to perform the corresponding game operation according to the game instruction. Referring to FIG. 7, transferring the operation permission of the first game client to the second game client may include the following steps S710 to S740.

In step S710, the operation permission of the first game client is transferred to the second game client. In step S720, the operation instruction is converted into a game instruction. In step S730, the game instruction is sent to the first game client, and the game instruction received by the first game client is sent to the cloud game server. In step S740, the cloud game server controls the game to perform the corresponding game operation according to the game instruction.

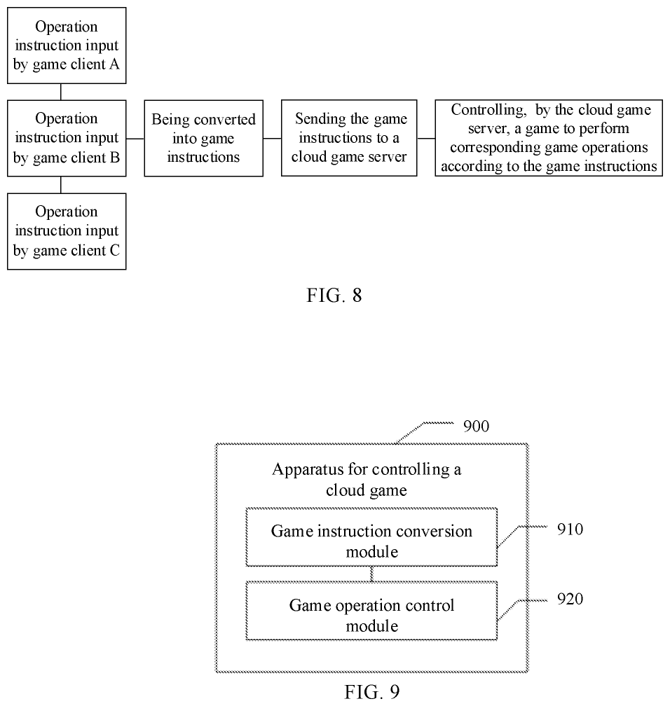

In an embodiment of the present disclosure, as shown in FIG. 8, the operation instructions input by different game clients (the operation instruction input by game client A, the operation instruction input by game client B, and the operation instruction input by game client C) may be converted into game instructions, the game instructions may be sent to the cloud game server, and the cloud game server may control the game to perform the corresponding game operations according to the game instructions.

In some embodiments of the present disclosure, the operation instruction input by the first game client is obtained, the operation instruction is converted into the game instruction, and the game instruction is sent to the cloud game server, so that the cloud game server controls the game to perform the corresponding game operation according to the game instruction.

In the method for controlling a cloud game provided by the embodiment of the present disclosure, the operation instruction input by the client can be converted into the game instruction corresponding to the server, and the game operation can be controlled according to the converted instruction. On one hand, the game developer does not need to perform adaptive development for different game devices, avoiding consideration of the instruction input manner of the same instruction in different game devices, reducing the repeated work of the developer, and further reducing the development cost of the game. On the other hand, since the instruction input by the game device is converted into the instruction corresponding to the server, the user does not need to adjust the control manner, reducing the playing cost of the user and improving the game experience of the player.

It should be noted that the above drawings are merely illustrative description of the processes included in the method according to the example embodiments of the present disclosure, and are not for limitation purposes. It is easy to understand that the processes shown in the above drawings do not indicate or limit the time sequence of these processes. In addition, it is also easy to understand that these processes may be performed synchronously or asynchronously, for example, in a plurality of modules.

In addition, there is further provided an apparatus for controlling a cloud game according to some embodiments of the present disclosure. Referring to FIG. 9, an apparatus 900 for controlling a cloud game includes a game instruction conversion module 910 and a game operation control module 920.

Among them, the game instruction conversion module is configured to obtain an operation instruction input by a first game client and convert the operation instruction into a game instruction, where the type of the operation instruction is related to a game platform corresponding to a game client, the type of the game instruction is related to a cloud game server, and the game instruction is configured to indicate a game operation to be performed. The game operation control module is configured to send the game instruction to the cloud game server, so that the cloud game server controls the game to perform the corresponding game operation according to the game instruction.

In some embodiments of the present disclosure, based on the above solutions, an operation instruction input by a first game client is obtained, the operation instruction is converted into a game instruction, and the apparatus further includes a transfer operation response unit and a first instruction conversion unit. The transfer operation response unit is configured to transfer the operation permission of the first game client to a second game client in response to a permission transfer operation. The first instruction conversion unit is configured to obtain an operation instruction input by the second game client, and convert the operation instruction into a game instruction.

In some embodiments of the present disclosure, the game instruction is sent to the cloud game server, and the apparatus further includes an instruction sending unit configured to receive the game instruction by the first game client and send the game instruction to the cloud game server.

In some embodiments of the present disclosure, based on the above solutions, the operation instruction is converted into the game instruction, and the apparatus further includes an instruction mapping rule obtaining unit and a second instruction conversion unit. The instruction mapping rule obtaining unit is configured to obtain an instruction mapping rule between the operation instruction and the game instruction. The second instruction conversion unit is configured to convert the operation instruction into the game instruction according to the instruction mapping rule.

In some embodiments of the present disclosure, based on the above solutions, the cloud game server has an instruction conversion interface corresponding to a plurality of game platforms, and after the cloud game server controls the game to perform a corresponding game operation according to the game instruction, the apparatus further includes a back-transmission game instruction generation unit and a third instruction conversion unit.

The back-transmission game instruction generation unit is configured to generate a back-transmission game instruction when the cloud game server transmits back to the first game client for the game instruction, where the type of the back-transmission game instruction is the same as the type of the game instruction. The third instruction conversion unit is configured to convert the back-transmission game instruction into an operation instruction corresponding to the game platform of the first game client through the instruction conversion interface.

In some embodiments of the present disclosure, based on the above solutions, after performing the corresponding game operation according to the game instruction, the apparatus further includes a game screen obtaining unit configured to obtain a game screen corresponding to the game, and display the game screen on a display component of the first game client.

In some embodiments of the present disclosure, based on the above solutions, the game screen is displayed on a display component of the first game client, and the apparatus further includes a game screen encoding unit and a screen information decoding unit. The game screen encoding unit is configured to encode the game screen to obtain screen information, and send the screen information to the first game client. The screen information decoding unit is configured to decode the screen information on the first game client to obtain the game screen, and display the game screen on the display component of the first game client.

According to the apparatus for controlling a cloud game provided by the present disclosure, the instruction input by the client can be converted into the instruction corresponding to the server, and the game operation can be controlled according to the converted instruction. On one hand, the game developer does not need to perform adaptive development for different game devices, avoiding consideration of the instruction input manner of the same instruction in different game devices, reducing the repeated work of the developer, and further reducing the development cost of the game. On the other hand, since the instruction input by the game device is converted into the instruction corresponding to the server, the user does not need to adjust the control manner, reducing the playing cost of the user and improving the game experience of the player.

Since various functional modules of the apparatus for controlling a cloud game according to the example embodiments of the present disclosure correspond to the steps of the example embodiments of the method for controlling a cloud game, for details not disclosed in the apparatus embodiments of the present disclosure, reference can be made to the above embodiments of the method for controlling a cloud game in the present disclosure.

It should be noted that although several modules or units of a device configured as performing actions are mentioned in the above detailed description, such partitioning is not mandatory. In fact, according to embodiments of the present disclosure, the features and functions of two or more modules or units described above may be concretized in one module or unit. By the contrast, the features and functions of one module or unit described above may be further divided into a plurality of modules or units for concretization.

In addition, according to some embodiments of the present disclosure, there is further provided an electronic device capable of implementing the method for controlling a cloud game.

Those skilled in the art will appreciate that various aspects of the present disclosure may be implemented as a system, method, or program product. Therefore, various aspects of the present disclosure may be specifically implemented in the following form: a complete hardware embodiment, a complete software embodiment (including firmware, microcode, etc.), or an embodiment combining hardware and software, which may be collectively referred to here as a “circuit”, “module” or “system”.

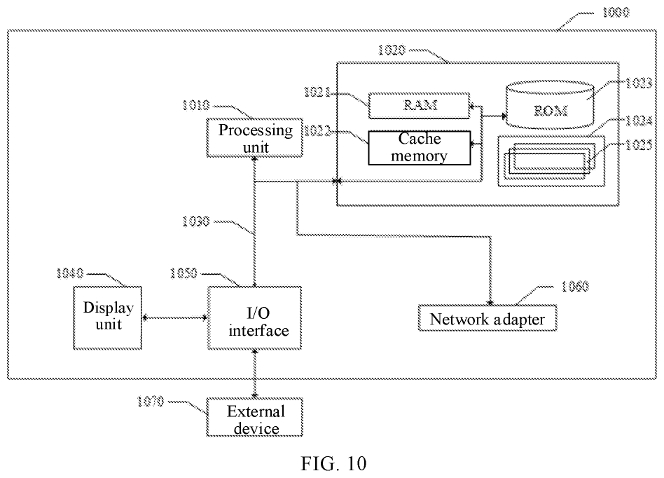

The electronic device 1000 according to the embodiment of the present disclosure is described below with reference to FIG. 10. The electronic device 1000 shown in FIG. 10 is merely an example, and should not bring any limitation to the functions and use ranges of the embodiments of the present disclosure.

As shown in FIG. 10, the electronic device 1000 is shown in the form of a general-purpose computing device. The components of the electronic device 1000 may include, but are not limited to: at least one processing unit 1010, at least one storage unit 1020, a bus 1030 connecting different system components (including the storage unit 1020 and the processing unit 1010), and a display unit 1040.

Among them, the storage unit stores a program code, and the program code may be executed by the processing unit 1010, so that the processing unit 1010 perform the steps according to various example embodiments of the present disclosure described in the above “example method” part of the present specification. For example, the processing unit 1010 may perform the step S110 and the step S120 as shown in FIG. 1. In step S110, an operation instruction input by a first game client is obtained, and the operation instruction is converted into a game instruction, where a type of the operation instruction is related to a game platform corresponding to a game client, a type of the game instruction is related to the cloud game server, and the game instruction is configured to indicate a game operation to be performed. In step S120, the game instruction is sent to the cloud game server, so that the cloud game server controls the game to perform the corresponding game operation according to the game instruction.

In some embodiments of the present disclosure, based on the above solutions, obtaining the operation instruction input by the first game client and converting the operation instruction into the game instruction includes: in response to a permission transfer operation, transferring an operation permission of the first game client to a second game client; and, obtaining an operation instruction input by the second game client, and converting the operation instruction into a game instruction.

In some embodiments of the present disclosure, based on the above solutions, sending the game instruction to the cloud game server includes: receiving the game instruction by the first game client, and sending the game instruction to the cloud game server.

In some embodiments of the present disclosure, based on the above solutions, converting the operation instruction into the game instruction includes: obtaining an instruction mapping rule between the operation instruction and the game instruction; and, converting the operation instruction into the game instruction according to the instruction mapping rule.

In some embodiments of the present disclosure, based on the above solutions, the cloud game server has an instruction conversion interface corresponding to a plurality of game platforms, and after the cloud game server controls the game to perform the corresponding game operation according to the game instruction, the method further includes: generating a back-transmission game instruction when the cloud game server transmits back to the first game client for the game instruction, where the type of the back-transmission game instruction is the same as the type of the game instruction; and, converting the back-transmission game instruction into an operation instruction corresponding to the game platform of the first game client through the instruction conversion interface.

In some embodiments of the present disclosure, based on the above solutions, after performing the corresponding game operation according to the game instruction, the method further includes: obtaining a game screen corresponding to the game, and displaying the game screen on a display component of the first game client.

In some embodiments of the present disclosure, based on the above solutions, the game screen is displayed on the display component of the first game client, and the method further includes: obtaining screen information by encoding the game screen, and sending the screen information to the first game client; and, obtaining the game screen by decoding the screen information on the first game client, and displaying the game screen on the display component of the first game client.

According to the electronic device provided by the present disclosure, the instruction input by the client can be converted into the instruction corresponding to the server, and the game operation can be controlled according to the converted instruction. On one hand, the game developer does not need to perform adaptive development for different game devices, avoiding consideration of the instruction input manner of the same instruction in different game devices, reducing the repeated work of the developer, and further reducing the development cost of the game. On the other hand, since the instruction input by the game device is converted into the instruction corresponding to the server, the user does not need to adjust the control manner, reducing the playing cost of the user and improving the game experience of the player.

The storage unit 1020 may include a readable medium in the form of a volatile storage unit, such as a random access memory unit (RAM) 1021 and/or a cache memory unit 1022, and may further include a read-only memory unit (ROM) 1023.

The storage unit 1020 may also include a program/utility 1024 having a group of (at least one) program module 1025 including, but not limited to, an operating system, one or more applications, other program modules, and program data, each or some combination of which may include an implementation of a network environment.

The bus 1030 may be representing one or more of several types of bus structures, including a memory unit bus or a memory unit controller, a peripheral bus, a graphics acceleration port, a processing unit, or a local bus using any one of various bus structures.

The electronic device 1000 may also communicate with one or more external devices 1070 (for example, a keyboard, a pointing device, a Bluetooth device, etc.), may also communicate with one or more devices that enable a user to interact with the electronic device 1000, and/or may communicate with any device (for example, a router, a modem, etc.) that enables the electronic device 1000 to communicate with one or more other computing devices. Such communication may be performed through an input/output (I/O) interface 1050. Furthermore, the electronic device 1000 may also communicate with one or more networks (for example, a local area network (LAN), a wide area network (WAN), and/or a public network, such as the Internet) through the network adapter 1060. As shown in the drawings, the network adapter 1060 communicates with other modules of electronic device 1000 through the bus 1030. It should be understood that, although not shown in the drawings, other hardware and/or software modules may be used in conjunction with the electronic device 1000, including but not limited to: microcode, device drivers, redundant processing units, external disk drive arrays, RAID systems, tape drives, and data backup storage systems, etc.

Through the description of the above embodiments, those skilled in the art will readily understand that the example embodiments described here may be implemented by software, or may be implemented by software in combination with necessary hardware. Therefore, the technical solutions according to the embodiments of the present disclosure may be embodied in the form of a software product. The software product may be stored in a non-volatile storage medium (which may be a CD-ROM, a USB flash disk, a mobile hard disk, etc.) or on a network, and may include several instructions to enable a computing device (which may be a personal computer, a server, a terminal device, or a network device, etc.) to perform the method according to the embodiments of the present disclosure.

In some embodiments of the present disclosure, there is further provided a computer-readable storage medium, and a program product capable of implementing the method described in the specification is stored on the computer-readable storage medium. In some possible embodiments, various aspects of the present disclosure may also be implemented in the form of a program product that includes program code. The program code is configured to enable the terminal device to perform the steps of the various example embodiments of the present disclosure described in the above “example method” part of the specification when the program product runs on the terminal device.

In some embodiments of the present disclosure, an operation instruction input by a first game client is obtained, and the operation instruction is converted into a game instruction, where the type of the operation instruction is related to a game platform corresponding to a game client, the type of the game instruction is related to a cloud game server, and the game instruction is configured to indicate a game operation to be performed. The game instruction is sent to a cloud game server, so that the cloud game server controls the game to perform a corresponding game operation according to the game instruction.

In some embodiments of the present disclosure, based on the above solutions, obtaining the operation instruction input by the first game client and converting the operation instruction into the game instruction includes: in response to a permission transfer operation, transferring an operation permission of the first game client to a second game client; and, obtaining an operation instruction input by the second game client, and converting the operation instruction into a game instruction.

In some embodiments of the present disclosure, based on the above solutions, sending the game instruction to the cloud game server includes: receiving the game instruction by the first game client, and sending the game instruction to the cloud game server.

In some embodiments of the present disclosure, based on the above solutions, converting the operation instruction into the game instruction includes: obtaining an instruction mapping rule between the operation instruction and the game instruction; and, converting the operation instruction into the game instruction according to the instruction mapping rule.

In some embodiments of the present disclosure, based on the above solutions, the cloud game server has an instruction conversion interface corresponding to a plurality of game platforms, and after the cloud game server controls the game to perform the corresponding game operation according to the game instruction, the method further includes: generating a back-transmission game instruction when the cloud game server transmits back to the first game client for the game instruction, where the type of the back-transmission game instruction is the same as the type of the game instruction; and, converting the back-transmission game instruction into an operation instruction corresponding to the game platform of the first game client through the instruction conversion interface.

In some embodiments of the present disclosure, based on the above solutions, after performing the corresponding game operation according to the game instruction, the method further includes: obtaining a game screen corresponding to the game, and displaying the game screen on a display component of the first game client.

In some embodiments of the present disclosure, based on the above solutions, the game screen is displayed on the display component of the first game client, and the method further includes: obtaining screen information by encoding the game screen, and sending the screen information to the first game client; and, obtaining the game screen by decoding the screen information on the first game client, and displaying the game screen on the display component of the first game client.

According to the computer-readable storage medium provided by the present disclosure, the instruction input by the client can be converted into the instruction corresponding to the server, and the game operation can be controlled according to the converted instruction. On one hand, the game developer does not need to perform adaptive development for different game devices, avoiding consideration of the instruction input manner of the same instruction in different game devices, reducing the repeated work of the developer, and further reducing the development cost of the game. On the other hand, since the instruction input by the game device is converted into the instruction corresponding to the server, the user does not need to adjust the control manner, reducing the playing cost of the user and improving the game experience of the player.

The computer-readable signal medium may include data signals propagated in a baseband or as a part of a carrier, where readable program code is carried. Such propagated data signals may take various forms, including, but not limited to, electromagnetic signals, optical signals, or any suitable combination of the above. The readable signal medium may also be any readable medium other than the readable storage medium. The readable medium may send, propagate, or transmit a program configured to be used by or combined with an instruction execution system, an apparatus, or a device.

The program code contained on the readable medium may be transmitted with any suitable medium, including but not limited to wireless, wire, optical cable, RF, etc., or any suitable combination of the above.

Program code configured to perform the operations of the present disclosure may be written in any combination of one or more programming languages, including object-oriented programming languages, such as Java, C++, etc., and also including conventional procedural programming languages, such as “C” language or similar programming languages. The program code may be executed entirely on the user computing device, partially on the user device, as a stand-alone software package, partially on the user computing device and partially on the remote computing device, or entirely on the remote computing device or the server. In the situation involving a remote computing device, the remote computing device may be connected to a user computing device through any type of network, including a local area network (LAN) or a wide area network (WAN), or may be connected to an external computing device (for example, be connected via the Internet using an Internet service provider).

In addition, the above drawings are merely illustrative description of the processes included in the method according to the example embodiments of the present disclosure, and are not for limitation purposes. It is easy to understand that the processes shown in the above drawings do not indicate or limit the time sequence of these processes. In addition, it is also easy to understand that these processes may be performed synchronously or asynchronously, for example, in a plurality of modules.

Other embodiments of the present disclosure will be apparent to those skilled in the art from consideration of the specification and practice of the present disclosure. The present disclosure is intended to cover any variations, uses, or adaptations of the present disclosure, which follow the general principles of the present disclosure and include common general knowledge or conventional technical means in the art not disclosed in the present disclosure. The specification and embodiments may be considered as examples only, with a true scope and spirit of the present disclosure being indicated by the claims.

1. A method for controlling a cloud game, performed on a terminal device or a server, and comprising:
obtaining an operation instruction input by a first game client, and converting the operation instruction into a game instruction; wherein a type of the operation instruction is determined according to a game platform corresponding to the first game client, a type of the game instruction is a type of an instruction to be received by a cloud game server, and the game instruction is configured to indicate a game operation to be performed; and
sending the game instruction to the cloud game server, wherein the cloud game server controls a game virtual object to perform the game operation according to the game instruction.

2. The method according to claim 1, wherein obtaining the operation instruction input by the first game client, and converting the operation instruction into the game instruction, comprises:
transferring an operation permission of the first game client to a second game client in response to a permission transfer operation; and
obtaining an operation instruction input by the second game client, and converting the operation instruction into the game instruction.

3. The method according to claim 2, wherein sending the game instruction to the cloud game server comprises:
sending the game instruction received by the first game client to the cloud game server.

4. The method according to claim 1, wherein converting the operation instruction into the game instruction comprises;
obtaining an instruction mapping rule between the operation instruction and the game instruction; and
converting the operation instruction into the game instruction according to the instruction mapping rule.

5. The method according to claim 1, wherein the cloud game server comprises an instruction conversion interface corresponding to a plurality of game platforms; and, the method further comprises:
generating a back-transmission game instruction in response to determining that the cloud game server transmits back to the first game client for the game instruction, wherein a type of the back-transmission game instruction is the same as the type of the game instruction; and
converting the back-transmission game instruction into an operation instruction corresponding to a game platform of the first game client through the instruction conversion interface.

6. The method according to claim 1, wherein, the method further comprises:
obtaining a game screen corresponding to the game, and displaying the game screen on a display component of the first game client.

7. The method according to claim 1, wherein displaying the game screen on the display component of the first game client, further comprises:
obtaining screen information by encoding the game screen, and sending the screen information to the first game client; and
obtaining the game screen by decoding the screen information on the first game client, and displaying the game screen on the display component of the first game client.

8. (canceled)

9. A non-transitory computer-readable storage medium, storing a computer program; wherein, when the computer program is executed by a processor, a method for controlling a cloud game is implemented, and the method comprises:
obtaining an operation instruction input by a first game client, and converting the operation instruction into a game instruction; wherein a type of the operation instruction is determined according to a game platform corresponding to the first game client, a type of the game instruction is a type of an instruction to be received by a cloud game server, and the game instruction is configured to indicate a game operation to be performed; and
sending the game instruction to the cloud game server, wherein the cloud game server controls a game virtual object to perform the game operation according to the game instruction.

10. An electronic device, comprising:
one or more processors; and
a memory, configured to store one or more programs; wherein, when the one or more programs are executed by the one or more processors, the one or more processors are enabled to implement a method for controlling a cloud game, and the method comprises:
obtaining an operation instruction input by a first game client, and converting the operation instruction into a game instruction; wherein a type of the operation instruction is determined according to a game platform corresponding to the first game client, a type of the game instruction is a type of an instruction to be received by a cloud game server, and the game instruction is configured to indicate a game operation to be performed; and
sending the game instruction to the cloud game server, wherein the cloud game server controls a game virtual object to perform the game operation according to the game instruction.

11. The method according to claim 1, wherein the type of the operation instruction comprises at least one of;
a touch input type, wherein the game platform corresponding to the first game client is a mobile phone platform;
a handle input type, wherein the game platform corresponding to the first game client is a game machine platform; or
a keyboard and mouse input type, wherein the game platform corresponding to the first game client is a computer platform.

12. The method according to claim 1, wherein converting the operation instruction into the game instruction comprises:
configuring a conversion tool for converting the operation instruction into the game instruction in a software development kit (SDK); and
converting the operation instruction into the game instruction through the SDK.

13. The method according to claim 2, wherein the permission transfer operation comprises at least one of a key operation, a touch operation or a voice control.

14. The method according to claim 2, wherein transferring the operation permission of the first game client to the second game client in response to the permission transfer operation comprises at least one of:
transferring the operation permission of the first game client to the second game client through one permission transfer operation; or
transferring the operation permission of the first game client to the second game client through a plurality of permission transfer operations.

15. The method according to claim 4, wherein instruction mapping rule comprises an instruction mapping table, and the instruction mapping table comprises a mapping relationship between the operation instruction and the game instruction.

16. The method according to claim 1, further comprising: sending the operation instruction to an instruction processing middleware;
wherein converting the operation instruction into the game instruction comprises: converting the operation instruction to the game instruction in the instruction processing middleware.

17. The method according to claim 7, wherein encoding the game screen comprises encoding the game screen through at least one of entropy encoding, predictive encoding, transform encoding or hybrid encoding.

18. The non-transitory computer-readable storage medium according to claim 9, wherein obtaining the operation instruction input by the first game client, and converting the operation instruction into the game instruction, comprises:
transferring an operation permission of the first game client to a second game client in response to a permission transfer operation; and
obtaining an operation instruction input by the second game client, and converting the operation instruction into a game instruction.

19. The non-transitory computer-readable storage medium according to claim 9, wherein converting the operation instruction into the game instruction comprises:
obtaining an instruction mapping rule between the operation instruction and the game instruction; and
converting the operation instruction into the game instruction according to the instruction mapping rule.

20. The electronic device according to claim 10, wherein obtaining the operation instruction input by the first game client, and converting the operation instruction into the game instruction, comprises:
transferring an operation permission of the first game client to a second game client in response to a permission transfer operation; and
obtaining an operation instruction input by the second game client, and converting the operation instruction into a game instruction.

21. The electronic device according to claim 10, wherein converting the operation instruction into the game instruction comprises:
obtaining an instruction mapping rule between the operation instruction and the game instruction; and
converting the operation instruction into the game instruction according to the instruction mapping rule.
